(19) United States
(12) Patent Application Publication
(10) Pub. No.: US 2006/0162235 A1
(43) Pub. Date: Jul. 27, 2006

(54) Mosquito trapping lamp

(76) Inventors: Chun-Chia Shih, Changhua County (TW); Jen Yen Yen, Changhua County (TW)

Correspondence Address: PRO-TECHTOR INTERNATIONAL, 20775 Norada Court, Saratoga, CA, 95070-3018, US

(21) Appl. No.: 11/044,923

(22) Filed: Jan. 26, 2005

(51) Int. Cl. A01M 1/04; A01M 1/02

(52) U.S. Cl. 43/107; 43/113

(57) ABSTRACT

Provided is a mosquito trapping lamp comprising a pointed rod; a water bowl including a socket projected upward from its center, a kerosene container put into the socket and projected therefrom, a cap put on the container, a wick pierced through the cap to expose its head and submerge its remaining portion in the container, a base, and a sleeve extended downward from a center of the base; and a transparent funnel having a tube fitted on the socket to enclose the container and the cap. Burning the wick and putting a cover on the funnel will attract mosquitoes onto an outer surface of the funnel prior to dropping them into the water bowl. Either the sleeve is put on the rod and the rod is inserted into earth in an outdoor environment or the base is put on a flat supporting surface.

### BACKGROUND OF THE INVENTION

1. Field of Invention

The present invention relates to mosquito trapping devices and more particularly to a kerosene based mosquito trapping lamp applicable for indoor or outdoor environment.

2. Related Art

A conventional mosquito trapping lamp is shown in FIG. 1. The lamp comprises a slender rod 1 having a sharp lower end, a water bowl 2 snugly put on an upper portion of the rod 1, a socket 3 projected upward from a center of the bowl 2, a bulb 5 fitted in the socket 3, a power cord 6 having one end coupled to the bulb 5 and the other end formed as a plug, a transparent funnel 4 fitted on the socket 3 with the bulb 5 projected upward from its center, and a cover fitted on both the funnel 4 and the bowl 2.

For use in an outdoor environment (e.g., garden) in the night, first insert the sharp end of the rod 1 into earth for fastening. Next, remove the cover. Next, plug the other end of the power cord 6 into an outlet (e.g., wall outlet) for taking current so as to illuminate the bulb 5. Mosquitoes are thus attracted onto a smooth outer surface of the funnel 4 due to the enabled bulb 5 and heat thus caused. However, the staying of mosquitoes onto the outer surface is temporarily. Eventually, almost all mosquitoes fall into the bowl 2 and are drown. As an end, the purpose of preventing mosquitoes from biting people in the garden is substantially achieved.

However, the prior art suffered from several disadvantages. For example, taking current from an outlet is sometimes difficult and is even impossible in an outdoor environment. Moreover, the lamp may not be able to install by inserting the sharp end of the rod 1 insert into earth, for example in an indoor environment. Such much limits the application of the lamp to an outdoor environment only. Thus, the need for improvement still exists.

### SUMMARY OF THE INVENTION

It is therefore an object of the present invention to provide a kerosene based mosquito trapping lamp applicable for indoor or outdoor environment. The above and other objects of the present invention are realized by providing a mosquito trapping lamp comprising a slender rod having a sharp lower end; a water bowl including a socket projected upward from its center, a cylindrical kerosene container with an open top put into the socket and projected therefrom, a cap put on the kerosene container, a wick pierced through the cap to expose its head and submerge its remaining portion in kerosene in the kerosene container, a circular base, and a sleeve extended downward from a center of the base wherein a bottom of the sleeve is at the same elevation as or less than that of the base; a transparent funnel having a lower cylindrical tube fitted on the socket to enclose both the kerosene container and the cap; and a cover, whereby burning the wick head and putting the cover on the funnel will attract mosquitoes onto an outer surface of the funnel prior to dropping them into the water bowl, and wherein either the sleeve is put on a top of the rod and the sharp end of the rod is inserted into earth in an outdoor environment or the base is put on a flat supporting surface either in an indoor environment or the insertion of the rod into earth is not possible.

In one aspect of the present invention, the bottom of the sleeve is at the same elevation as that of the base.

The above and other objects, features and advantages of the present invention will become apparent from the following detailed description taken with the accompanying drawings.

### BRIEF DESCRIPTION OF THE DRAWINGS

FIG. 1 is a longitudinal sectional view of a conventional mosquito trapping lamp;

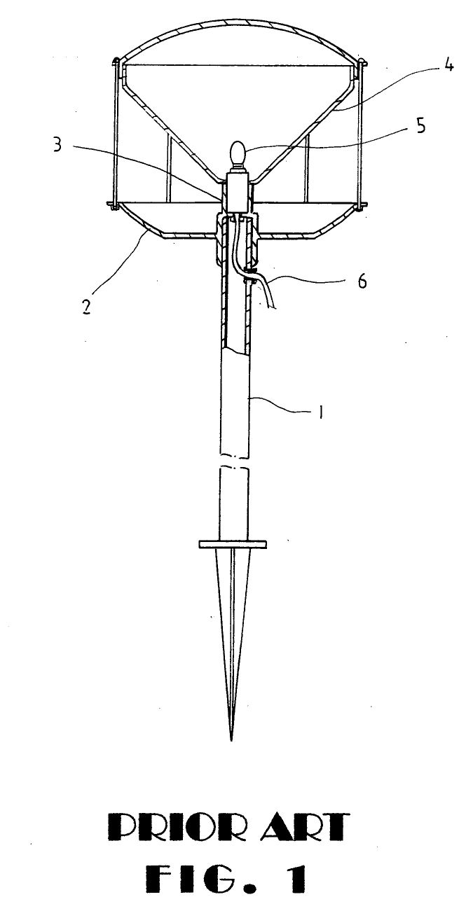

FIG. 2 is an exploded view of a preferred embodiment of mosquito trapping lamp according to the invention;

FIG. 3 is a longitudinal sectional view of the assembled lamp of FIG. 2, where the lamp is ready to be used in an outdoor environment; and

FIG. 4 is a view similar to FIG. 3, where the rod is removed and the lamp is ready to be used in an indoor environment.

### DETAILED DESCRIPTION OF THE INVENTION

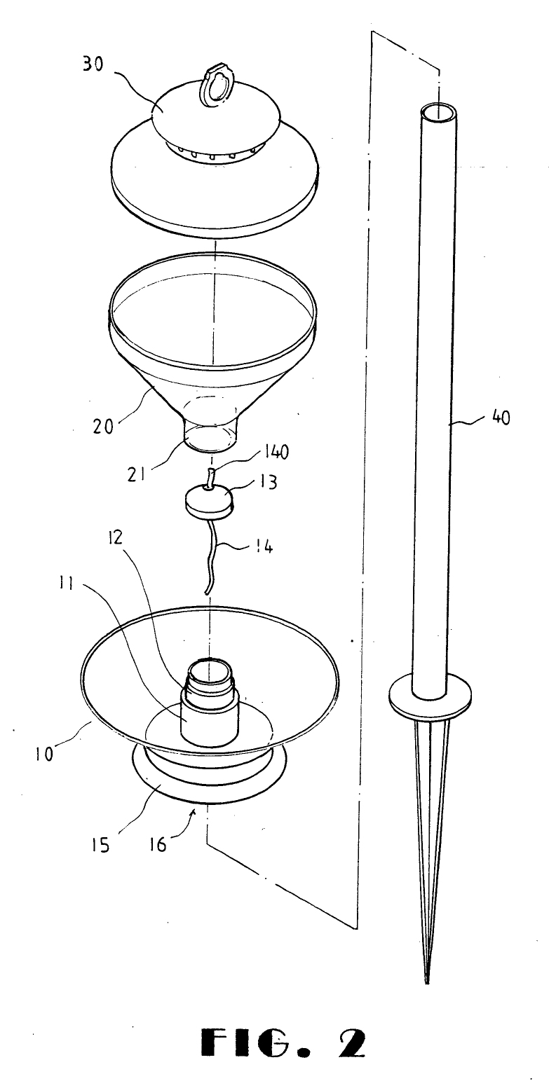

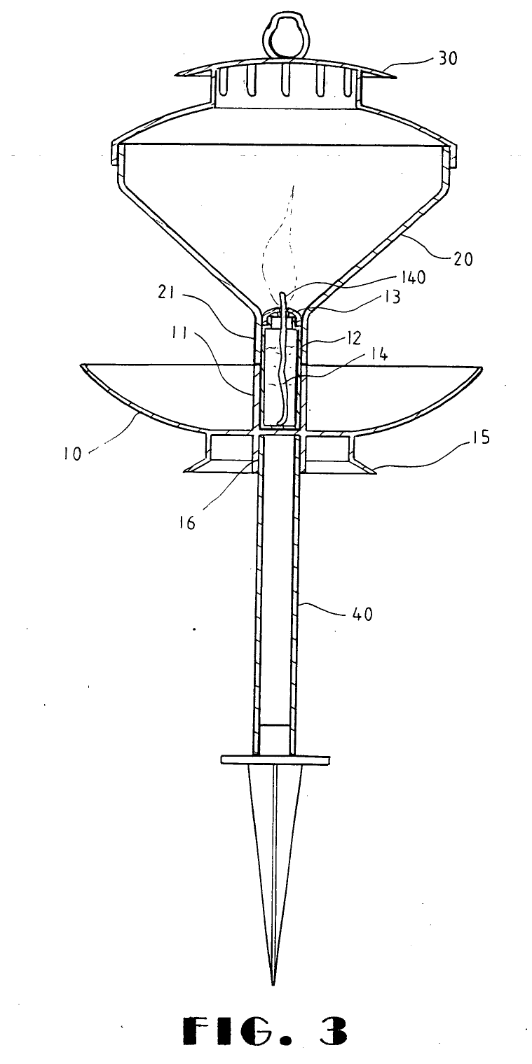

Referring to FIGS. 2 and 3, there is shown a mosquito trapping lamp constructed in accordance with a preferred embodiment of the invention. The lamp comprises a slender rod 40 having a sharp lower end, a water bowl 10 including a socket 11 projected upward from its center, a cylindrical kerosene container 12 with an open top snugly put into the socket 11 and projected therefrom, a cap 13 put on the kerosene container 12, a wick 14 pierced through the cap 13 to expose its head 140, a circular base 15, and a sleeve 16 extended downward from a center of the base 15 to be flush therewith in the bottom, a transparent funnel 20 having a lower cylindrical tube 21 fitted on the socket 11 to enclose both the kerosene container 12 and the cap 13, and a cover 30 put on the funnel 20.

Referring to FIG. 3 specifically, for use in an outdoor environment (e.g., garden) in the night, first insert the sharp end of the rod 40 into earth for fastening. Next, assemble the funnel 20 and the water bowl 10 together with the wick 14 submerged in kerosene in the kerosene container 12. Next, neatly put the sleeve 16 on a top of the rod 40. Next, burn the wick head 140 and put the cover 30 on the funnel 20. Mosquitoes are thus attracted onto a smooth outer surface of the funnel 20 due to the burning wick 14 and heat thus caused. However, the staying of mosquitoes onto the outer surface is temporarily. Eventually, almost all mosquitoes fall into the water bowl 10 and are drown. As an end, the purpose of preventing mosquitoes from biting people in the garden is substantially achieved. In view of the above, the invention has the follow advantage. No external power is required.

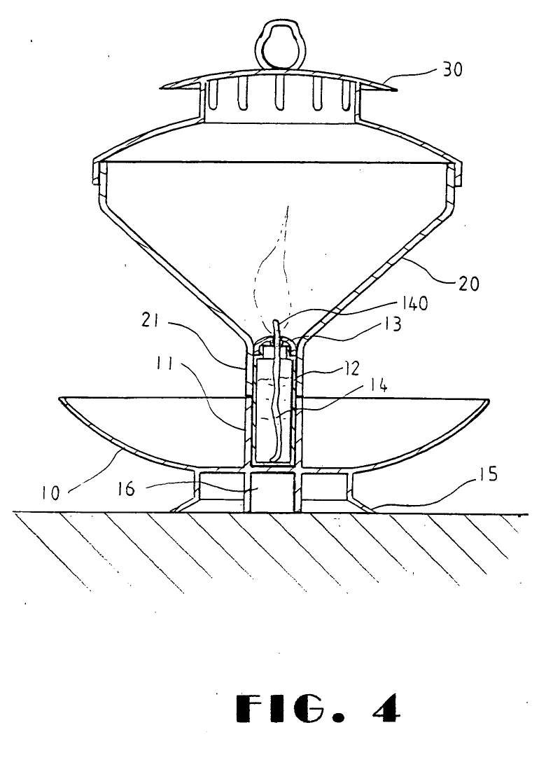

Referring to FIG. 4, there is shown another embodiment of the invention applicable for an indoor environment or a place where insertion of the rod 40 into earth in an outdoor environment is not possible. In this case, installation of the lamp is done by simply putting the base 15 on a flat supporting ground, table, or the like. In view of the above, the invention has another advantage of being highly adaptable. That is, the invention is applicable for an indoor or outdoor environment.

While the invention herein disclosed has been described by means of specific embodiments, numerous modifications and variations could be made thereto by those skilled in the art without departing from the scope and spirit of the invention set forth in the claims.

What is claimed is:

1. A mosquito trapping lamp comprising:
a slender rod having a sharp lower end;
a water bowl including a socket projected upward from its center, a cylindrical kerosene container with an open top put into the socket and projected therefrom, a cap put on the kerosene container, a wick pierced through the cap to expose its head and submerge its remaining portion in kerosene in the kerosene container, a circular base, and a sleeve extended downward from a center of the base wherein a bottom of the sleeve is at the same elevation as or less than that of the base;
a transparent funnel having a lower cylindrical tube fitted on the socket to enclose both the kerosene container and the cap; and
a cover,
whereby burning the wick head and putting the cover on the funnel will attract mosquitoes onto an outer surface of the funnel prior to dropping them into the water bowl, and wherein either the sleeve is put on a top of the rod and the sharp end of the rod is inserted into earth in an outdoor environment or the base is put on a flat supporting surface either in an indoor environment or the insertion of the rod into earth is not possible.

2. The mosquito trapping lamp of claim 1, wherein the bottom of the sleeve is at the same elevation as that of the base.
